(19) United States
(12) Patent Application Publication
(10) Pub. No.: US 2010/0316349 A1
(43) Pub. Date: Dec. 16, 2010

(54) Content reproduction apparatus, content provision apparatus, and content distribution system

(75) Inventor: Kae Nagano, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/800,506

(22) Filed: May 17, 2010

(30) Foreign Application Priority Data
Jun. 16, 2009 (JP) P2009-143355

(51) Int. Cl. H04N 5/775; H04N 9/80

(52) U.S. Cl. 386/230; 386/241; 386/E05.07

(57) ABSTRACT

Disclosed herein is a content reproduction apparatus including: a reading device configured to read a title from a recording medium in accordance with an application program; a video content display control device configured to download from a content provision apparatus a video content having the title in accordance with the application program to display the video content on a display device; a moving picture scene information creation device configured to create as metadata a start point time and an end point time which correspond to a moving picture scene desired and designated by a user, with a related image invoking the moving picture scene, and to store the metadata and the related image as moving picture scene information onto an external storage device; and an introduction screen creation device configured to create an introduction screen for introducing the moving picture scene to display the introduction screen onto the display device.

### CROSS-REFERENCE TO RELATED APPLICATION

The present application claims priority from Japanese Patent Application No. JP 2009-143355 filed in the Japanese Patent Office on Jun. 16, 2009, the entire content of which is incorporated herein by reference.

### BACKGROUND OF THE INVENTION

1. Field of the Invention

The present invention relates to a content reproduction apparatus, a content provision apparatus, and a content distribution system. More particularly, the invention relates to a content distribution system that connects a Blu-ray disk player capable of reproducing video content in streaming mode, with a video streaming server capable of distributing that video content in streaming mode over the Internet.

2. Description of the Related Art

Heretofore, it has been common practice for people wishing to retain the recollections of the movies they saw to purchase the brochures or DVDs (digital versatile disks) of these movies, or some other tangible things associated therewith.

However, these forms of preserving one's recollections of moves rests on the passive attitude of merely accepting whatever may have been offered by the movie distributors. There has been no way for users to retain their impressions or recollections of movies by getting actively involved in combining their favorite scenes of the movies with their own comments in a manner arranged by the users themselves.

Today, video clips and TV images are posted at personal moving picture sharing sites on the Internet. However, these postings are basically meant to serve purposes different from the desire of the users to preserve the recollections of their viewing experiences.

There exist car audio integrated navigation systems whereby a particular audio portion desired by the user of a music CD is ripped in accordance with the ripping start time and ripping end time designated by the user, the ripped portion getting stored onto an external storage medium. One such system is disclosed in Japanese Patent Laid-open No. 2005-196918 (hereinafter as Patent Document 1).

### SUMMARY OF THE INVENTION

The car audio integrated navigation system discussed in Patent Document 1 is merely capable of ripping the user-desired audio portion of the music CD and storing the ripped portion onto the external storage medium; the system is incapable of retaining visual scenes of the user's recollections.

The present invention has been made in view of the above circumstances and provides a content reproduction apparatus, a content provision apparatus, and a content distribution system capable of preserving a portion of video content as a moving picture scene making up part of a user's recollections.

In carrying out the present invention and according to one embodiment thereof, there is provided a content reproduction apparatus including: a reading device, a video content display control device, a moving picture scene information creation device, and an introduction screen creation device. The reading device is configured to read a title from a recording medium in accordance with an application program held on the recording medium. The video content display control device is configured to download from a content provision apparatus a video content having the title in accordance with the application program and to display the video content on a display device. The moving picture scene information creation device is configured such that while a reproduced image of the video content is being displayed, the moving picture scene information creation device creates as metadata a start point time and an end point time which correspond to a moving picture scene desired by a user and which are designated by the user, together with a related image invoking the moving picture scene, and the moving picture scene information creation device further stores the metadata and the related image as moving picture scene information onto an external storage device. The introduction screen creation device is configured to create an introduction screen for introducing the moving picture scene using the moving picture scene information and to display the introduction screen onto the display device.

Where the inventive content reproduction apparatus outlined above is implemented, the user is allowed visually to verify a reproduced image of a video content downloaded from the content provision apparatus and currently displayed. At the same time, the start point time and end point time corresponding to the user-designated moving picture scene of the video content are created as metadata along with an image related to that moving picture scene. The metadata and the related image are stored as moving picture scene information onto an external storage device. Later, the moving picture scene retained by the user as his or her recollections of the video content may be introduced through an introduction screen created on the basis of the moving picture scene information.

According to another embodiment of the present invention, there is provided a content provision apparatus including: a distribution device, a moving picture scene information storage device, and an introduction screen creation device. The distribution device is configured to distribute a video content in response to a reproduction start request coming from a content reproduction apparatus regarding a title read from a recording medium in accordance with an application program held on the recording medium. The moving picture scene information storage device is configured such that while the video content is being distributed by the distribution device, the moving picture scene information storage device receives from the content reproduction apparatus metadata constituted by a start point time and an end point time which correspond to a moving picture scene desired by a user and which are designated by the user, and the moving picture scene information storage device further receives a related image invoking the moving picture scene from the content reproduction apparatus before storing the metadata and the related image as moving scene information onto a storage device. The introduction screen creation device is configured to create an introduction screen for introducing the moving picture scene using the moving picture scene information and to transmit the introduction screen to the content reproduction apparatus.

Where the inventive content provision apparatus outlined above is implemented, during distribution of a video content, the start point time and end point time which correspond to a moving picture scene desired by a user and which are designated by the user through a content reproduction apparatus are received as metadata together with a related image invoking the moving picture scene. The metadata and the related image thus received are stored as moving picture scene information onto a storage device. It is then possible to provide an introduction screen through which to introduce the moving picture scene retained by the user as his or her recollections of the video content upon request from the content reproduction apparatus.

According to a further embodiment of the present invention, there is provided a content distribution system, including: a content reproduction apparatus; and a content provision apparatus connected to the content reproduction apparatus via a network. The content reproduction apparatus includes: a reading device, a video content display control device, a moving picture scene information creation device, an introduction screen creation device, a transmission device, and a moving picture scene reproduction device. The reading device is configured to read a title from a recording medium in accordance with an application program held on the recording medium. The video content display control device is configured to download from the content provision apparatus a video content having the title in accordance with the application program and to display the video content on a display device. The moving picture scene information creation device is configured such that while a reproduced image of the video content is being displayed, the moving picture scene information creation device creates as metadata a start point time and an end point time which correspond to a moving picture scene desired by a user and which are designated by the user, together with a related image invoking the moving picture scene, and the moving picture scene information creation device further stores the metadata and the related image as moving picture scene information onto an external storage device. The introduction screen creation device is configured to create an introduction screen for introducing the moving picture scene using the moving picture scene information and to display the introduction screen onto the display device. The transmission device is configured such that when the introduction screen is selected, the transmission device transmits to the content provision apparatus a reproduction start request for a temporally delimited portion of the video content which corresponds to the moving picture scene designated by the start point time and the end point time. The moving picture scene reproduction device is configured to download the video content corresponding to the reproduction start request from the content provision apparatus and to display the video content on the display device. The content provision apparatus includes a distribution device configured to distribute the temporally delimited portion of the video content corresponding to the reproduction start request coming from the content reproduction apparatus regarding the video content having the title.

Where the inventive content distribution system outlined above is implemented, the user is allowed visually to verify a reproduced image of a video content downloaded from the content provision apparatus and currently displayed by the content reproduction apparatus. At the same time, the start point time and end point time corresponding to the user-designated moving picture scene of the video content are created as metadata along with an image related to that moving picture scene. The metadata and the related image are stored as moving picture scene information onto an external storage device. Later, the moving picture scene retained by the user as his or her recollections of the video content may be introduced through an introduction screen created on the basis of the moving picture scene information. Thereafter, the moving picture scene of the temporally delimited portion of the video content corresponding to the start point time and end point time may be downloaded from the content provision apparatus and provided to the content reproduction apparatus.

According to an even further embodiment of the present invention, there is provided a content distribution system including: a content reproduction apparatus; and a content provision apparatus connected to the content reproduction apparatus via a network. The content reproduction apparatus includes: a reading device, a video content display control device, and a moving picture scene information creation device. The reading device is configured to read a title from a recording medium in accordance with an application program held on the recording medium. The video content display control device is configured to download from the content provision apparatus a video content having the title in accordance with the application program and to display the video content on a display device. The moving picture scene information creation device is configured such that while a reproduced image of the video content is being displayed, the moving picture scene information creation device creates as metadata a start point time and an end point time which correspond to a moving picture scene desired by a user and which are designated by the user, together with a related image invoking the moving picture scene, and the moving picture scene information creation device further transmits the metadata and the related image as moving picture scene information to the content provision apparatus. The content provision apparatus includes: a distribution device, a moving picture scene information storage device, and an introduction screen creation device. The distribution device is configured to distribute the video content in response to a reproduction start request coming from the content reproduction apparatus regarding the video content having the title. The moving picture scene information storage device is configured to receive the moving picture scene information from the content reproduction apparatus and to store the moving picture scene information onto a storage device. The introduction screen creation device is configured to create an introduction screen for introducing the moving picture scene using the moving picture scene information and to transmit the introduction screen to the content reproduction apparatus.

Where the inventive content distribution system outlined above is implemented, while a video content is being distributed by the content provision apparatus, the start point time and end point time which correspond to a moving picture scene desired by a user and which are designated by the user through the content reproduction apparatus are received as metadata together with a related image invoking the moving picture scene. The metadata and the related image thus received are stored as moving picture scene information onto a storage device. It is then possible to provide the content reproduction apparatus with an introduction screen through which to introduce the moving picture scene retained by the user as his or her recollections of the video content upon request from that content reproduction apparatus.

As outlined above, there is provided according to the embodiment of the present invention a content reproduction apparatus whereby a user is allowed visually to verify a reproduced image of a video content downloaded from a content provision apparatus and currently displayed. Concurrently, the start point time and end point time corresponding to the user-designated moving picture scene of the video content are created as metadata along with an image related to that moving picture scene. The metadata and the related image are then stored as moving picture scene information onto an external storage device. Later, the moving picture scene retained by the user as his or her recollections of the video content may be introduced through an introduction screen created on the basis of the moving picture scene information.

Also as outlined above, there is provided according to the embodiment of the present invention a content provision apparatus whereby, during distribution of a video content, the start point time and end point time which correspond to a moving picture scene desired by a user and which are designated by the user through a content reproduction apparatus are received as metadata together with a related image invoking the moving picture scene. The metadata and the related image are then stored as moving picture scene information onto a storage device. It is then possible to provide an introduction screen through which to introduce the moving picture scene retained by the user as his or her recollections of the video content upon request from the content reproduction apparatus.

Also as outlined above, there is provided according to the embodiment of the present invention a content distribution system whereby a user is allowed visually to verify a reproduced image of a video content downloaded from a content provision apparatus and currently displayed by a content reproduction apparatus. Concurrently, the start point time and end point time corresponding to the user-designated moving picture scene of the video content are created as metadata along with an image related to that moving picture scene. The metadata and the related image are then stored as moving picture scene information onto an external storage device. Later, the moving picture scene retained by the user as his or her recollections of the video content may be introduced through an introduction screen created on the basis of the moving picture scene information. Thereafter, the moving picture scene of the temporally delimited portion of the video content corresponding to the start point time and end point time may be downloaded from the content provision apparatus and provided to the content reproduction apparatus.

Also as outlined above, there is provided according to the embodiment of the present invention a content distribution system whereby, while a video content is being distributed by a content provision apparatus, the start point time and end point time which correspond to a moving picture scene desired by a user and which are designated by the user through a content reproduction apparatus are received as metadata together with a related image invoking the moving picture scene. The metadata and the related image are then stored as moving picture scene information onto a storage device. It is then possible to provide the content reproduction apparatus with an introduction screen through which to introduce the moving picture scene retained by the user as his or her recollections of the video content upon request from that content reproduction apparatus.

### BRIEF DESCRIPTION OF THE DRAWINGS

FIG. 1 is a schematic view showing an overall configuration of a content distribution system as one embodiment of the present invention;

FIG. 2 is a schematic block diagram showing a circuit diagram of a BD (Blu-ray disk) recorder;

FIG. 3 is a schematic view showing a Blu-ray disk targeted to be reproduced;

FIG. 4 is a schematic block diagram showing a circuit structure of a video streaming server;

FIG. 5 is a schematic diagram showing a typical sequence of a favorite moving picture scene information registration process;

FIG. 6 is a schematic view explanatory of screen transitions;

FIG. 7 is a flowchart of a subroutine constituting a metadata creation and recording process;

FIG. 8 is a schematic view explanatory of how favorite moving picture scenes are registered;

FIG. 9 is a schematic view showing a directory structure of a local storage;

FIG. 10 is a schematic view showing details of a metadata file;

FIGS. 11A, 11B, and 11C are schematic views showing typical introduction screens;

FIG. 12 is a schematic diagram showing a typical sequence of a favorite moving picture scene reproduction and modification process;

FIG. 13 is a schematic view showing a typical recollections album screen;

FIG. 14 is a flowchart of a subroutine constituting a metadata modification process;

FIG. 15 is a schematic view explanatory of a metadata file creation and recording process as one variation of the present invention;

FIG. 16 is a schematic block diagram showing a circuit structure of a video streaming server as another variation of the present invention;

FIGS. 17A, 17B, and 17C are schematic views showing a typical example (1) of introduction screens as a further variation of the present invention;

FIG. 18 is a schematic view showing a typical example (2) of introduction screens as an even further variation of the present invention; and

FIG. 19 is a schematic view showing a recollections album screen as a still further variation of the present invention.

### DETAILED DESCRIPTION OF THE PREFERRED EMBODIMENTS

Some preferred embodiments of the present invention will now be described under the following headings:

1. Preferred embodiment

2. Other variations

### 1. Preferred Embodiment

### [1-1. Overall Configuration of Content Distribution System]

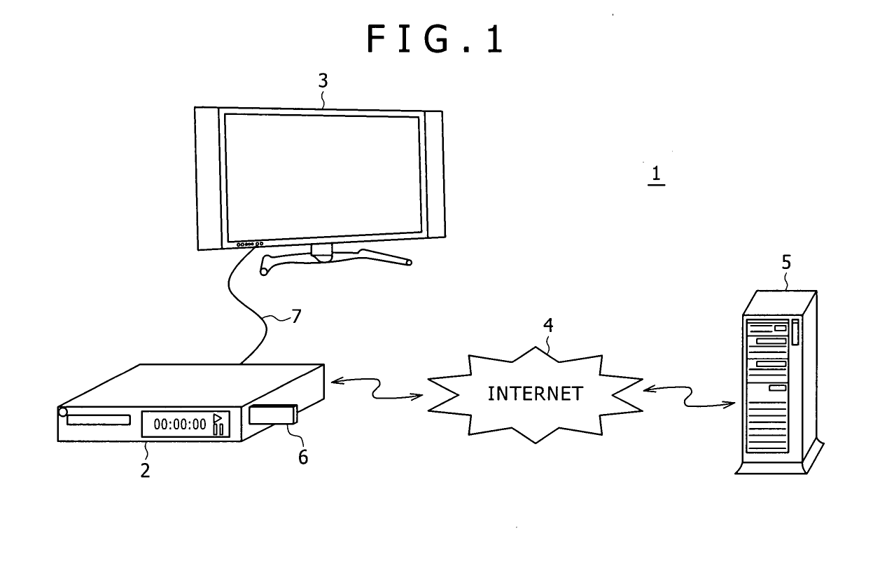

In FIG. 1, reference symbol 1 denotes a content distribution system implemented as an overall embodiment of the present invention. The content distribution system 1 is made up of a Blu-ray disk recorder (called the BD recorder hereunder) 2, a TV set 3, and a video streaming server 5.

The BD recorder 2 is connected to the TV set 3 illustratively by way of an HDMI (high definition multimedia interface) cable 7. The BD recorder 2 is further connected to the video streaming server 5 via the Internet 4.

To the BD recorder 2 may be attached a detachable external storage section such as a USB (universal serial bus) memory 6. The USB memory 6 is used as a local storage in which to store various files (to be discussed later).

The external storage device for use as the local storage is not limited to the USB memory 6. Various other external storage sections may be used alternatively, including a memory card having a storage capacity of at least 1 gigabyte or a detachable small-sized hard disk drive.

### [1-2. Circuit Structure of BD Recorder]

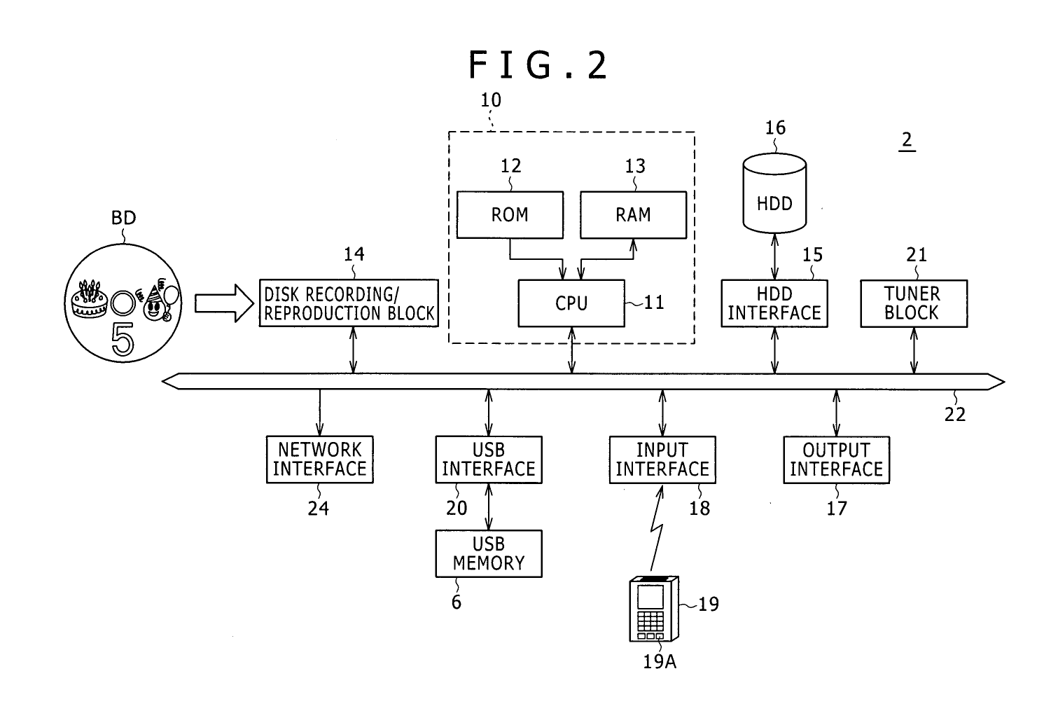

As shown in FIG. 2, a control block 10 connected to a system bus 22 in the BD recorder 2 is made up of a CPU (central processing unit) 11, a ROM (read only memory) 12, and a RAM (random access memory) 13.

The CPU 11 of the control block 10 executes basic processes of the BD recorder 2 in accordance with basic programs and diverse application programs loaded from the ROM 12 into the RAM 13 for program execution.

The CPU 11 of the control block 10 receives commands from a remote controller 19 through an input interface 18. Illustratively, if the received command is a write command or a read command, the control block 10 writes or reads data to or from a Blu-ray disk BD respectively via a disk recording/reproduction block 14.

The target to or from which the disk recording/reproduction block 14 writes or reads data is not limited to Blu-ray disks BD. Alternatively, various other optical disks such as DVD (digital versatile disk) or CD (compact disk) may be utilized as the target to write to or read from.

Upon receipt from the remote controller 19 of a command to write a TV program to a hard disk drive (HDD), the CPU 11 of the control block 10 causes a tuner block 21 to perform demodulation, descrambling, and decoding processes on digital satellite broadcast waves or the like to obtain video data. Under control of the CPU 11, the resulting video data is recorded to a hard disk drive 16 through a hard disk interface 15.

Likewise, upon receipt from the remote controller 19 of a command to read a TV program from the HDD, the CPU 11 of the control block 10 reads the video data of the TV program from the hard disk drive 16 through the hard disk interface 15. Under control of the CPU 11, the retrieved video data is output to the TV set 3 via an output interface 17.

Furthermore, upon receipt from the remote controller 19 of a video content streaming reproduction command, the CPU 11 of the control block 10 downloads the user-designated video content from the video streaming server 5 through a network interface 24 over the Internet 4. Under control of the CPU 11, the downloaded video content is reproduced in streaming mode.

At this point, the CPU 11 of the control block 10 causes either the hard disk drive 16 or the USB memory 6 temporarily to buffer the video content downloaded from the video streaming server 5. While being buffered, the video content is output to the TV set 3 through the output interface 17.

While the user-designated video content is being reproduced in streaming mode from the video streaming server 5, the CPU 11 of the control block 10 may create a metadata file or the like (to be discussed later) based on the user's operations on the remote controller 19 and store the created file into the USB memory 6 through a USB interface 20.

### [1-3. Blu-Ray Disk Targeted to be Reproduced]

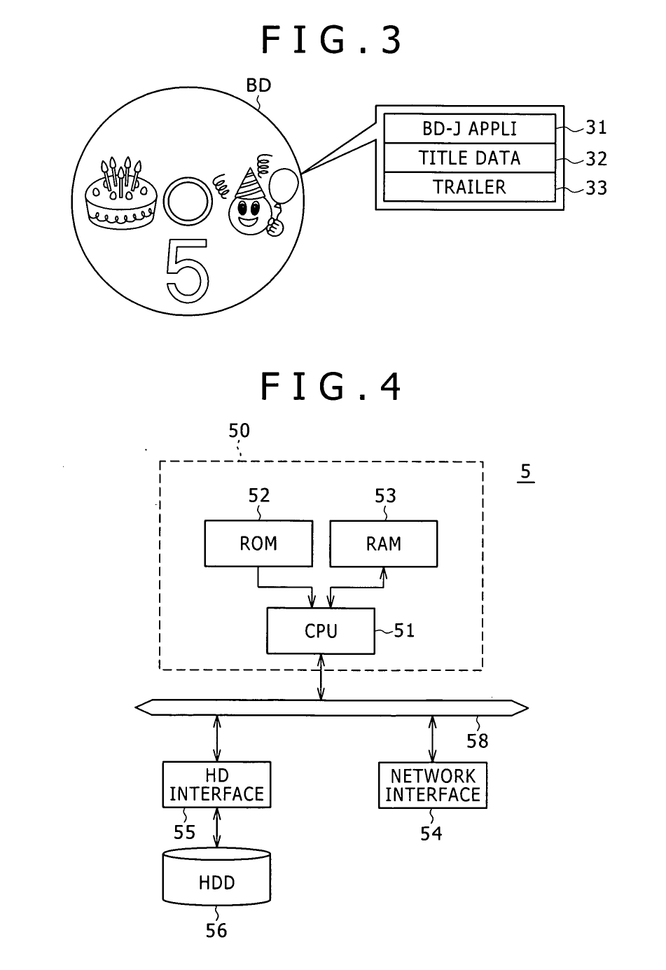

As shown in FIG. 3, the Blu-ray disk BD to be loaded into the BD recorder 2 contains the so-called BD-JAVA (registered trademark) application (called the BD-J Appli hereunder) 31. The BD-J Appli 31 allows a GUI (graphical user interface) display to be executed in interactive fashion.

The BD-J Appli 31 is an application program written in Java (registered trademark) language. As such, the BD-J Appli 31 permits connection to the Internet 4, enables the video contents related to the titles held on the Blu-ray disk BD to be downloaded, or allows the user to visit websites associated with the video contents of interest.

Illustratively, the Blu-ray disk BD shown in FIG. 3 contains title data 32 constituting the titles of a plurality of video contents produced for five-year-olds, but does not include the video contents corresponding to these titles.

The main reason for the exclusion of video contents from the above-mentioned Blu-ray disk BD is that this disk is intended primarily to introduce many titles and that the disk cannot accommodate all video contents corresponding to these titles due to capacity constraints. The video contents are to be downloaded from the video streaming server 5 as needed.

Instead, the Blu-ray disk BD contains a plurality of short video contents called trailers 33 in addition to the title data 32. When a preview button is pressed on the menu displayed in GUI form by the BD-J Appli 31, the BD recorder 2 causes the corresponding trailer 33 to be previewed.

The user having visually previewed the trailer 33 reproduced on the TV set 3 may press a full-reproduction button displayed in GUI form by the BD-J Appli 31. If that is the case, the BD recorder 2 downloads in full the video content corresponding to the previewed title from the video streaming server 5 for reproduction in streaming mode.

### [1-4. Circuit Structure of Video Streaming Server]

As shown in FIG. 4, a streaming management block 50 connected to a system bus 58 in the video streaming server 5 is made up of a CPU 51, a ROM 52, and a RAM 53. The streaming management block 50 performs streaming distribution of video contents and other processes in accordance with basic programs and the like loaded from the ROM 52 into the RAM 53 for program execution.

In practice, the CPU 51 of the streaming management block 50 may have one of the titles designated by the BD recorder 2 from the Blu-ray disk BD and receive a request to start streaming reproduction of the video content corresponding to the designated title from the BD recorder 2 via a network interface 54. With the title selected and with the request received, the CPU 51 goes to the next process.

At this point, the CPU 51 of the streaming management block 50 searches a hard disk drive 56 via a hard disk interface 55 for the video content corresponding to the designated title. While reading the video content in question, the CPU 51 distributes the retrieved content in streaming mode to the BD recorder 2 through the network interface 54 and over the Internet 4.

If a start point time code and an end point time code (to be discussed later) are designated by the BD recorder 2, the CPU 51 of the streaming management block 50 may temporally delimit the video content with the designated start point time code and end point time code. The CPU 51 may then distribute in streaming mode the temporally delimited portion of the video content as a user-designated favorite moving picture scene.

### [1-5. Sequence of Favorite Moving Picture Scene Information Registration Process]

Explained below is a typical sequence of a favorite moving picture scene information registration process whereby a temporally delimited portion (designated with a start point time code and an end point time code) constituting a favorite moving picture scene is registered as metadata in the USB memory 6 during streaming reproduction of a video content by the BD recorder 2.

In the BD recorder 2, the CPU 11 of the control block 10 carries out the favorite moving picture scene information registration process sequence in accordance with the BD-J Appli 31 held on the Blu-ray disk BD.

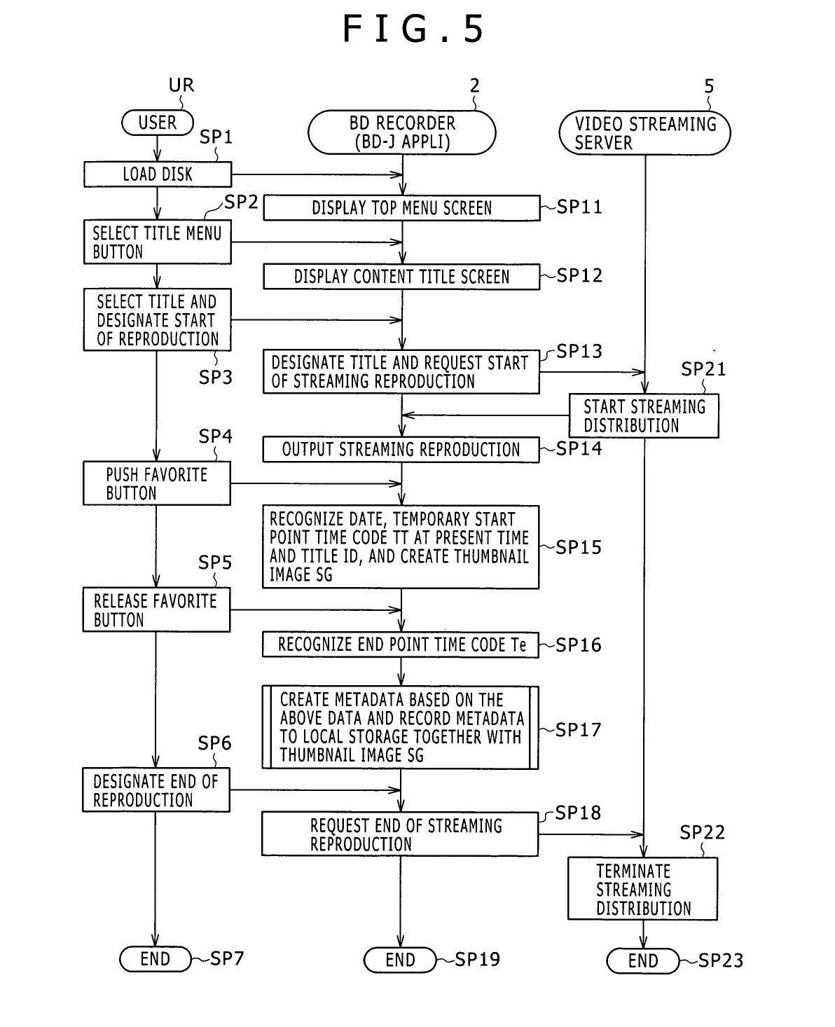

As shown in FIG. 5, the user UR in step SP1 loads the Blu-ray disk BD into the BD recorder 2. With the Blu-ray disk BD loaded, the user UR goes to step SP2.

At this point, the control block 10 of the BD recorder 2 in step SP11 causes a top menu screen TMG shown in FIG. 6 to appear on the TV set 3 in accordance with the BD-J Appli 31 on the Blu-ray disk BD. With the top menu screen TMG displayed, step SP12 is reached.

In accordance with the BD-J Appli 31, the control block 10 of the BD recorder 2 assigns a unique disk ID to the Blu-ray disk BD loaded by the user. This feature enables the BD recorder 2 to perform an authentication process (to be discussed later) verifying whether the currently loaded Blu-ray disk BD has already been registered with the video streaming server 5.

On the top menu screen TMG, a title menu button B1 is displayed to the left. Also displayed on the top menu screen TMG is a recollections album button B2 for viewing the favorite moving picture scene preserved by the user UR as his or her recollections.

In step SP2, the user UR visually checks the top menu screen TMG and selects the title menu button B1 for selecting the video content desired to be reproduced in streaming mode. From step SP2, the user UR goes to step SP3.

At this point, the control block 10 of the BD recorder 2 in step SP12 effects transition from the top menu screen TMG to a content title screen CTG for display on the TV set 3 in accordance with the BD-J Appli 31. From step SP12, the control block 10 goes to step SP13.

The content title screen CTG at this point shows a title image list TL that lists title images TL1 through TL10 evocative of their selectiveness and corresponding to a plurality of video contents, the title images being arranged in a circle for display in rotary fashion, each title image carrying a title and a suitable character.

On the content title screen CTG, a preview button B3 and a full-reproduction button B4 are provided. If the preview button B3 is selected, the control block 10 of the BD recorder 2 reproduces on the TV set 3 a preview of the trailer 33 which corresponds to one of the title images TL1 through TL10 and which was stored beforehand on this Blu-ray disk BD.

The user UR visually checks the reproduced preview video of the trailer 33, and decides whether or not to reproduce in full the video content corresponding to the trailer 33.

If one of the title images TL1 through TL10 is selected by the user UR from the title image list TL on the content title screen CTG and if the full-reproduction button B4 is pressed, then the control block 10 of the BD recorder 2 downloads the video content corresponding to the selected title and reproduces the downloaded content in fill in streaming mode.

In step SP3, the user UR visually checks the content title screen CTG, selects one of the title images TL1 through TL10 which is representative of the video content desired to be reproduced in streaming mode, and presses the full-reproduction button B4 to give a reproduction start command to the BD recorder 2. From step SP3, the user UR goes to step SP4.

At this point, the control block 10 of the BD recorder 2 goes to step SP13, recognizes the title corresponding to that one of the title images TL1 through TL10 which was selected on the content title screen CTG, and issues a streaming reproduction start request to the video streaming server 5 together with a corresponding title ID (identification) designated for use by the server 5. From step SP13, the control block 10 goes to step SP14.

In step SP21, the streaming management block 50 of the video streaming server 5 searches the hard disk drive 56 for the video content corresponding to the title ID based on the streaming reproduction start request coming from the BD recorder 2, reads the video content in question from the hard disk drive 56, and starts distributing the retrieved video content in streaming mode. From step SP21, the streaming management block 50 goes to step SP22.

In turn, the control block 10 of the BD recorder 2 in step SP14 causes the video content downloaded from the video streaming server 5 to be reproduced in streaming mode on the TV set 3 for visual verification by the user. From step SP14, the control block 10 goes to step SP15.

In step SP4, the user UR visually checks the video content being reproduced in streaming mode and, upon finding the start point of a favorite moving picture scene desired to be retained as his or her recollections, pushes a favorites button 19A (FIG. 2) on the remote controller 19A. From step SP4, the user UR goes to step SP5.

At this point, the control block 10 of the BD recorder 2 in step SP15 recognizes the current date at which the favorites button 19A is pushed on the remote controller 19, a temporary start point time code TT denoting the current time of day, and the title ID corresponding to the video content being reproduced in streaming mode.

At the same time in step SP15, the control block 10 of the BD recorder 2 creates a thumbnail image SG by reducing to a predetermined size the frame image corresponding to the temporary start point time code TT, and causes the RAM 13 to buffer the current date, temporary start point time code TT, title ID, and thumbnail image SG. From step SP15, the control block 10 goes to step SP16.

In step SP5, while continuously pushing the favorites button 19A (FIG. 2) on the remote controller 19, the user UR may detect the end point of the favorite moving picture scene desired to be preserved as his or her recollections. In that instant, the user UR releases the favorites button 19A. From step SP5, the user UR goes to step SP6.

At this point, the control block 10 of the BD recorder 2 in step SP16 recognizes an end point time code Te denoting the current time at which the favorites button 19A is released on the remote controller 19, and causes the RAM 13 to buffer the recognized end point time code Te. From step SP16, the control block 10 goes to step SP17.

In step SP17, the control block 10 of the BD recorder 2 creates metadata MD regarding the favorite moving picture scene on the basis of, the locations where the current date, temporary start point time code TT, title ID, end point time code Te, and thumbnail image SG are stored. The control block 10 records the created metadata MD as a metadata file MDF to the USB memory 6 along with the thumbnail image SG, before going to step SP18.

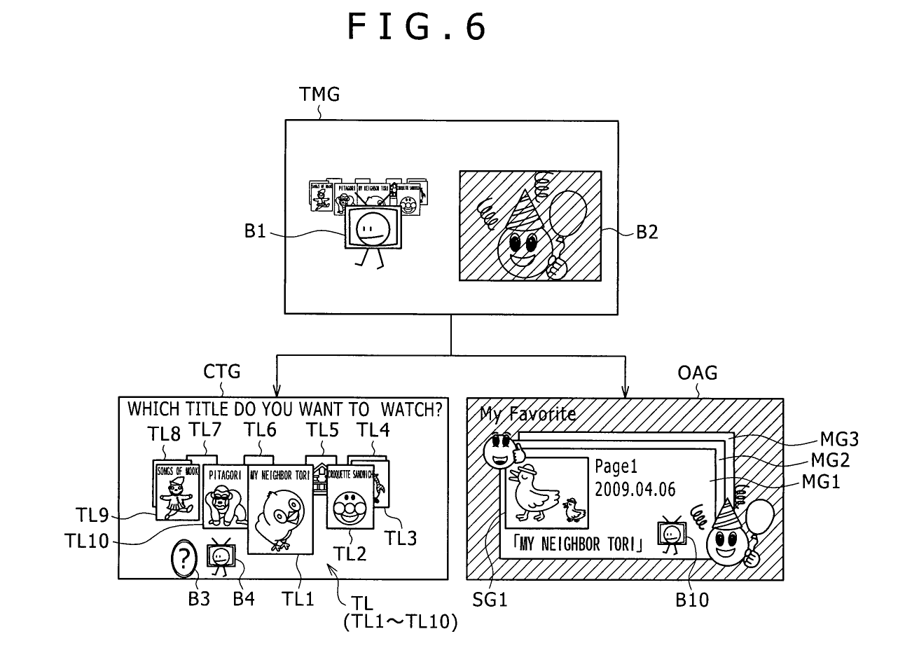

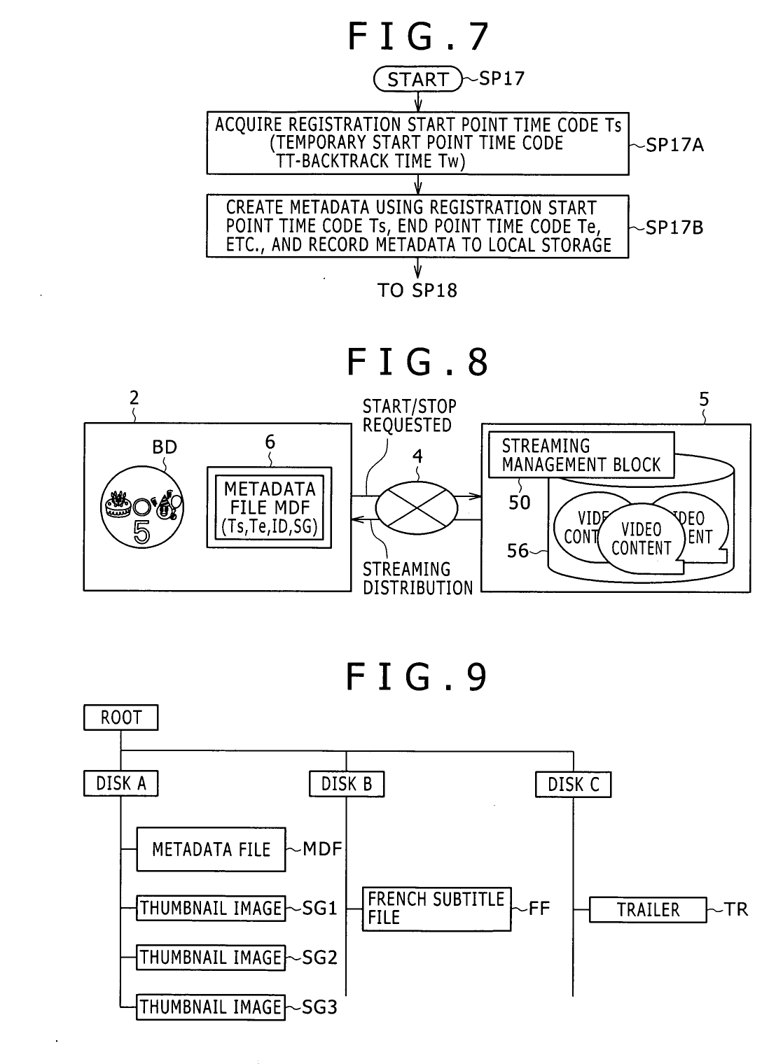

In practice, the control block 10 of the BD recorder 2 at this point goes to step SP17A in FIG. 7 and subtracts a predetermined backtrack time Tw (e.g., 5 seconds) from the temporary start point time code TT recognized in step SP15. The control block 10 thus obtains a registration start point time code Ts reached by backtracking by 5 seconds from the point in time at which the favorites button 19A was pushed. From step SP17A, the control block 10 goes to step SP17B.

In step SP17B, the control block 10 of the BD recorder 2 creates the metadata MD regarding the favorite moving picture scene illustratively on the basis of the locations where the registration start point time code Ts, title ID, end point time code Te, and thumbnail image SG are stored. The control block 10 records the created metadata MD as the metadata file MDF to the USB memory 6 along with the thumbnail image SG, and goes to step SP18.

In step SP6, the user UR operating the remote controller 19 gives the BD recorder 2 a command to stop the ongoing streaming reproduction of the video content. From step SP6, the user goes to step SP7 and brings the process to an end.

At this point, the control block 10 of the BD recorder 2 in step SP18 sends to the video streaming server 5 a streaming reproduction stop request based on the reproduction stop command. From step SP18, the control block 10 goes to step SP19 and terminates the process.

In step SP22, the streaming management block 50 of the video streaming server 5 stops the ongoing streaming distribution of the video content based on the streaming reproduction stop request coming from the BD recorder 2. From step S22, the streaming management block 50 goes to step SP23 and terminates the process.

With the content distribution system 1 in operation, the user UR viewing the video content being reproduced in streaming mode from the video streaming server 5 may push the favorites button 19A to determine the registration start point time code Ts and end point time code Te regarding the favorite moving picture scene, as illustrated in FIG. 8.

The control block 10 of the BD recorder 2 proceeds to create the metadata MD regarding the favorite moving picture scene illustratively on the basis of the locations where the registration start point time code Ts, title ID, end point time code Te, and thumbnail image SG are stored. The control block 10 records the created metadata MD as the metadata file MDF to the USB memory 6 along with the thumbnail image SG.

In the manner described above, the control block 10 of the BD recorder 2 can register the metadata file MDF and thumbnail image SG in the USB memory 6 serving as the local storage, as the information representative of the favorite moving picture scene desired by the user to be retained as his or her recollections.

### [1-6. Directory Structure of Local Storage]

FIG. 9 schematically shows a directory structure of the USB memory 6 accommodating the metadata file MDF and thumbnail image SG. In the USB memory 6, the root directory branches to disks such as disk A (this Blu-ray disk BD), disk B, and disk C. These disks are individually associated with the locations at which files and data are stored.

For example, disk A may be the Blu-ray disk BD used by this embodiment and destined for five-year-olds. Disk B may be a commercially available movie DVD, while disk C may be another DVD carrying a TV drama series available on the market.

In the USB memory 6, the above-described metadata file MD and thumbnail images SG (SG1 through SG3) are stored corresponding to disk A (Blu-ray disk BD) as the favorite moving picture scene information.

Also stored in the USB memory 6 is a French subtitle file FF which corresponds to disk B and which was downloaded over the network in conjunction with the movie of interest, as well as the most recent trailer TR which corresponds to disk C and which was downloaded over the network.

### [1-7. Details of Metadata File]

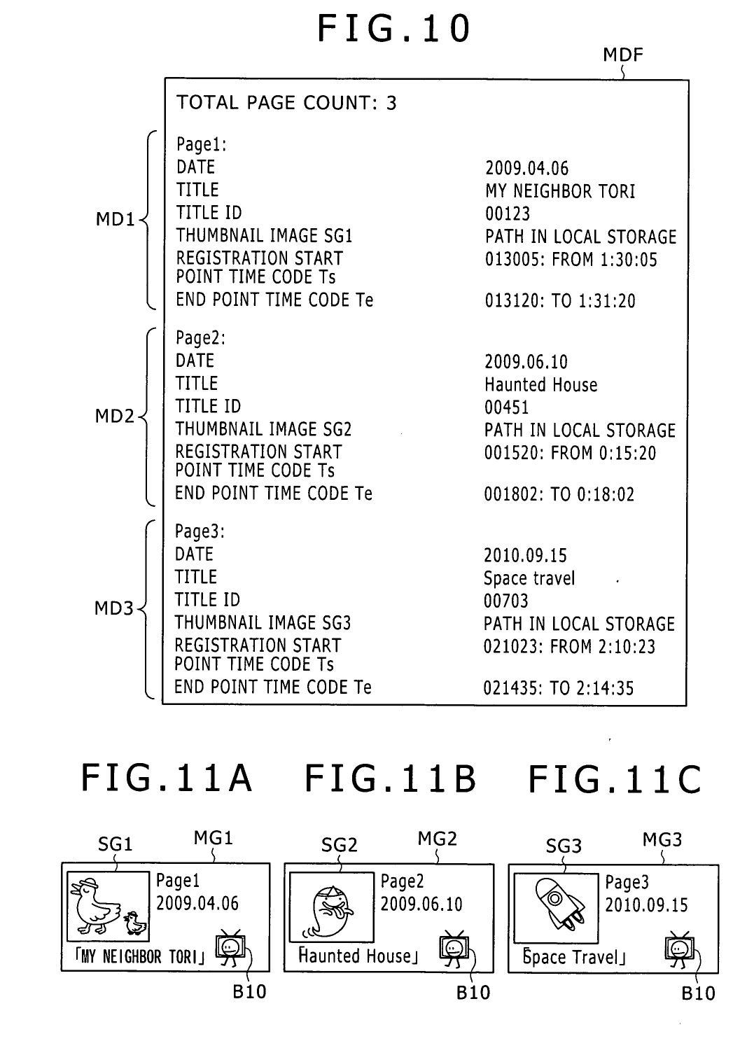

What follows is a detailed description of a metadata file MDF containing illustratively metadata MD1 through MD3 regarding three video contents corresponding to disk A (Blu-ray disk BD), as shown in FIG. 10.

This metadata file MDF holds the metadata MD1 through MD3 on a total of three pages regarding the favorite moving picture scenes of the three video contents.

Described on page 1 are the date “Apr. 6, 2009,” title “My Neighbor Tori,” title ID “00123,” thumbnail image SG1 “path in the local storage (i.e., data storage location),” registration start point time code Ts “013005,” and end point time code Te “013120.”

Described on page 2 are the date “Jun. 10, 2009,” title “Haunted House,” title ID “00451,” thumbnail image SG2 “path in the local storage (data storage location),” registration start point time code Ts “001520,” and end point time code Te “001802.”

Described on page 3 are the date “Sep. 15, 2009,” title “Space Travel,” title ID “00703,” thumbnail image SG3 “path in the local storage (data storage location),” registration start point time code Is “021023,” and end point time code Te “021435.”

Given the above-described data, the control block 10 of the BD recorder 2 creates an introduction screen MG1 for introducing the favorite moving picture scene such as one shown in FIG. 11A using the metadata MD1 and thumbnail image SG1 held on page 1 of the metadata file MDF.

Likewise, the control block 10 of the BD recorder 2 creates an introduction screen MG2 for introducing the favorite moving picture scene such as one shown in FIG. 11B using the metadata MD2 and thumbnail image SG2 retained on page 2 of the metadata file MDF.

In like manner, the control block 10 of the BD recorder 2 creates an introduction screen MG3 for introducing the favorite moving picture scene such as one shown in FIG. 11C using the metadata MD3 and thumbnail image SG3 stored on page 3 of the metadata file MDF.

The introduction screens MG1 through MG3 indicate the titles of the corresponding video contents, representative thumbnail images SG1 through SG3 in effect when the favorites button 19A was first pushed by the user regarding each of the titles, and dates at which the introduction screens MG1 through MG3 were created.

Upon visually checking the above-described introduction screens MG1 through MG3, the user UR can immediately recall the favorite moving picture scenes registered in conjunction with the video contents of interest. From the introduction screens MG1 through MG3, the user UR can also recognize the titles and dates related to the video contents in question.

### [1-8. Sequence of Favorite Moving Picture Scene Reproduction and Modification Process]

What follows is an explanation of a typical sequence of a favorite moving picture scene reproduction and modification process allowing the user to select any of the above-described introduction screens MG1 through MG3 so that the favorite moving picture scene preserved by the user as his or her recollections may be reproduced in streaming mode. During the streaming reproduction, the process further enables the user to modify the temporally delimited range of the favorite moving picture scene.

In this case, too, the CPU 11 of the control block in the BD recorder 2 executes the moving picture scene reproduction and modification process sequence in accordance with the BD-J Appli 31 held on the Blu-ray disk BD.

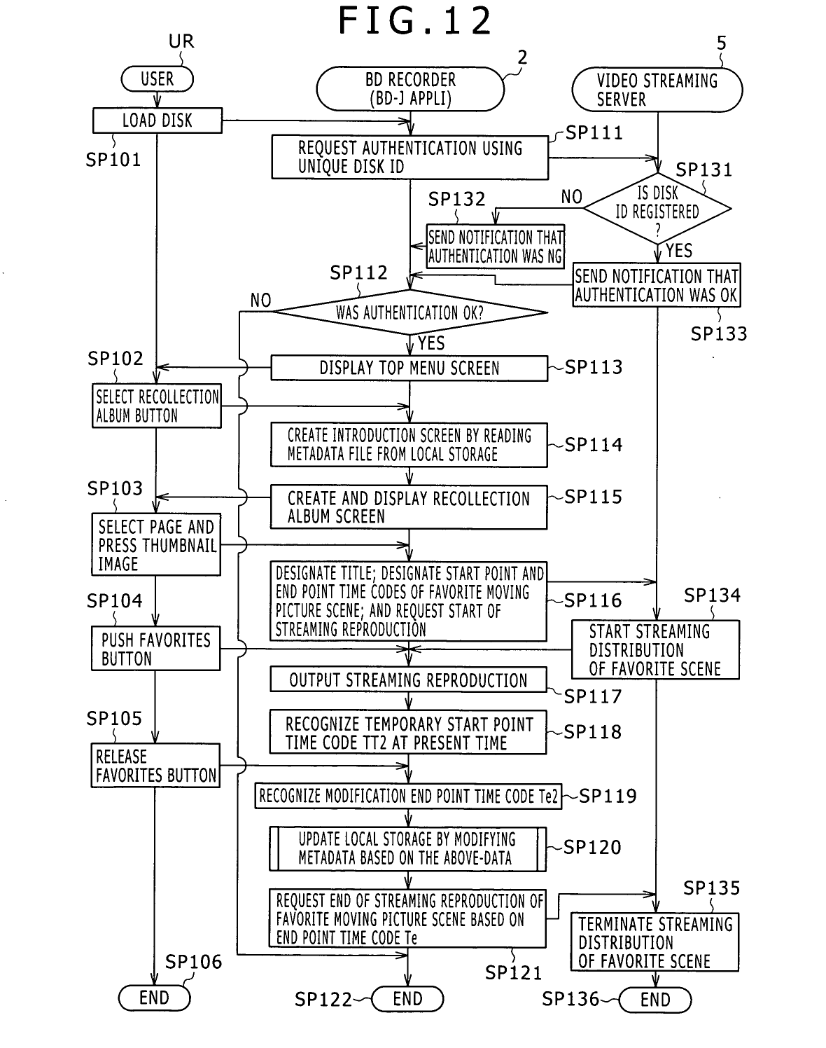

As shown in FIG. 12, the user UR first loads the Blu-ray disk BD into the BD recorder 2 in step SP101. From step SP101, the user UR goes to step SP102.

At this point, the control block 10 of the BD recorder 2 in step SP111 reads a unique disk ID assigned beforehand to the Blu-ray disk BD loaded by the user, and transmits the retrieved disk ID to the video streaming server to request authentication. From step SP111, the control block 10 goes to step SP112.

In step SP131, the streaming management block 50 of the video streaming server 5 checks to determine whether the disk ID has already been registered, in response to the authentication request coming from the BD recorder 2.

If the result of the check in step SP131 is negative, that means the Blu-ray disk BD in question belongs to an unauthorized user and has yet to have its disk ID registered with the video streaming server 5. In this case, the streaming management block 50 of the video streaming server 5 goes to step SP132.

In step SP132, the streaming management block 50 of the video streaming server 5 notifies the BD recorder 2 that the result of authentication was NG, which signifies that the request to start reproducing the video content in streaming mode regarding the Blu-ray disk BD cannot be accepted.

On the other hand, if the result of the check in step SP131 is affirmative, that means the Blu-ray disk BD belongs to the authorized user and has already been registered with the video streaming server 5. In this case, the streaming management block 50 of the video streaming server 5 goes to step SP133.

In step SP133, the streaming management block 50 of the video streaming server 5 notifies the BD recorder 2 that the result of authentication was OK and that the request to start reproducing the video content in streaming mode regarding the Blu-ray disk BD will be accepted. From step SP133, the streaming management block 50 goes to step SP134.

At this point, the control block 10 of the BD recorder 2 in step SP112 checks to determine whether the notification “Authentication OK” was received from the video streaming server 5. If the result of the check in step SP112 is negative, that means the favorite moving picture scene reproduction and modification process cannot be executed. In this case, the control block 10 goes to step SP122 and terminates the process.

If the result of the check in step SP112 is affirmative, that means the favorite moving picture scene reproduction and modification process regarding the Blu-ray disk BD in question can be performed. In this case, the control block 10 of the BD recorder 2 goes to step SP113.

In step SP113, the control block 10 of the BD recorder 2 causes the top menu screen TMG such as one shown in FIG. 6 to appear on the TV set 3 in keeping with the BD-J Appli 31. From step SP113, the control block 10 goes to step SP114.

On the top menu screen TMG, as discussed above, the title menu button B1 is displayed to the left. Also displayed on the top menu screen TMG is the recollections album button B2 for viewing the favorite moving picture scene.

In step SP102, the user UR visually checks the top menu screen TMG and selects the recollections album button B2 for viewing the favorite moving picture scenes retained beforehand by the user UR. From step SP102, the user goes to step SP103.

At this point, the control block 10 of the BD recorder 2 in step SP114 reads the metadata file MDF (FIG. 9) and thumbnail images SG1 through SG3 (FIG. 9) from the USB memory 8 used as the local storage. Based on the retrieved metadata file MDF and thumbnail images SG1 through SG3, the control block 10 creates the introduction screens MG1 through MG3 shown in FIGS. 11A 11B, and 11C. From step SP114, the control block 10 goes to step SP115.

In step SP115, the control block 10 of the BD recorder 2 creates a recollections album screen OAG shown in FIG. 6 using the introduction screens MG1 through MG3, and displays the created introduction screens MG1 through MG3 on the TV set 3. From step SP115, the control block 10 goes to step SP116.

The recollections album screen OAG displays the introduction screens MG1 through MG3 overlaid on three pages. The user UR is allowed to select any of these pages on the introduction screen.

In step SP103, the user UR selects a desired page (e.g., introduction screen MG1) from the recollections album screen OAG, and presses the thumbnail image SG (e.g., thumbnail image SG1) displayed on the selected page. From step SP103, the user UR goes to step SP104.

At this point, the control block 10 of the BD recorder 2 in step SP116 references the metadata MD1 corresponding to “page 1” of the metadata file MDF because the introduction screen MG1 on page 1 was selected, and reads the title ID, registration start point time code Ts, and end point time code Te.

Also in step SP116, the control block 10 of the BD recorder 2 designates for the video streaming server 5 the title of the video content based on the title ID, as well as the registration start point time code Ts and end point time code Te of the favorite moving picture scene. The control block 10 further gives the video streaming server 5 a request to start reproducing in streaming mode the favorite moving picture scene corresponding to the introduction screen MG1. From step SP116, the control block 10 goes to step SP117.

In step SP134, the streaming management block 50 of the video streaming server 5 starts streaming distribution of the video content in accordance with the content ID, registration start point time code Ts, and end point time code T2 designated by the BD recorder 2 in step SP134, the video content being retrieved starting from the registration start point time code Ts. From step SP134, the streaming management block 50 goes to step SP135.

In turn, the control block 10 of the BD recorder 2 in step SP117 reproduces in streaming mode only the temporally delimited portion of the video content registered beforehand as the favorite moving picture scene with the video streaming server 5. The reproduced scene is displayed on the TV set 3 for visual check by the user UR. From step SP117, the control block 10 goes to step SP118.

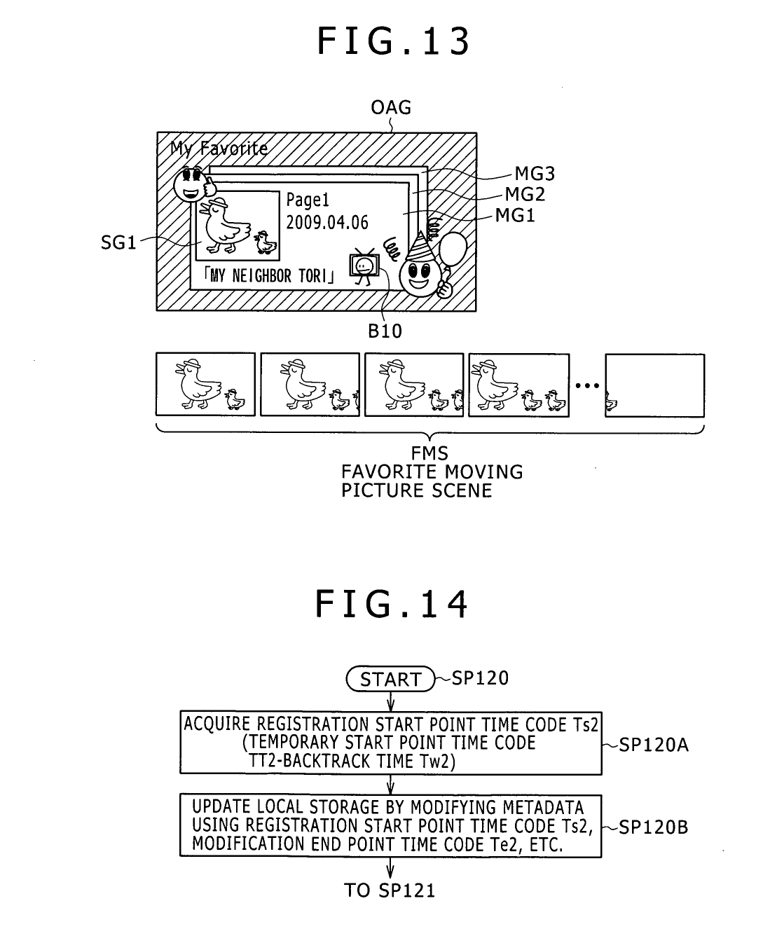

In the case above, as shown in FIG. 13, the control block 10 of the BD recorder 2 causes the TV set 3 to display in streaming mode a reproduced image of the favorite moving picture scene FMS composed of several frames. The display is provided when the control block 10 is triggered to do so by the user UR pressing the thumbnail image SG1 on the introduction screen MG1 from the recollections album screen OAG.

In step SP104, while visually checking the reproduced image of the favorite moving picture scene FMS in streaming mode, the user UR might want to narrow the temporally delimited range of the favorite moving picture scene FMS and register the modified scene anew. In that case, the user UR pushes the favorites button 19A (FIG. 2) on the remote controller 19 at a desired point in time during the streaming reproduction of the moving picture scene FMS. From step SP104, the user UR goes to step SP105.

At this point, the control block 10 of the BD recorder 2 in step SP118 recognizes a temporary start point time code TT2 indicative of the point in time at which the favorites button 19A was pushed on the remote controller 19. From step SP118, the control block 10 goes to step SP119.

In step SP105, while continuously pushing the favorites button 19A (FIG. 2) on the remote controller 19, the user UR might want to move up the end time of the favorite moving picture scene desired to be retained as his or her recollections. In such a case, the user UR releases the favorites button 19A at a desired point in time. From step SP105, the user UR goes to step SP106 and terminates the process.

At this point, the control block 10 of the BD recorder 2 in step SP119 recognizes a modified end point time code Te2 indicative of the point in time at which the favorites button 19A was released on the remote controller 19, and causes the RAM 13 to buffer the temporary start point time code TT2 and modified end point time code Te2. From step SP119, the control block 10 goes to step SP120.

In step SP120, the control block 10 of the BD recorder 2 updates the metadata file MDF by modifying the metadata MD1 regarding the favorite moving picture scene based on the temporary start point time code TT2, modified end point time code Te2, and other data. From step SP120, the control block 10 goes to step SP121.

On the recollections album screen (FIG. 13), a full-reproduction button B10 is displayed in each of the introduction screens MG1 through MG3. If the full-reproduction button B10 is pressed, the control block 10 of the BD recorder 2 causes the corresponding video content to be reproduced in full in streaming mode.

In practice, the control block 10 of the BD recorder 2 at this point goes to step SP120A in FIG. 14 and subtracts a predetermined backtrack time Tw2 (e.g., 3 seconds) from the temporary start point time code TT2 recognized in step SP118. The control block 10 thus obtains a registration start point time code Ts2 reached by backtracking by 3 seconds from the point in time at which the favorites button 19A was pushed. From step SP120A, the control block 10 goes to step SP120B.

In step SP120B, the control block 10 of the BD recorder 2 updates the metadata file MDF by modifying the metadata MD1 regarding the favorite moving picture scene based on the registration start point time code Ts2, modified end point time code Te2, and other data. The control block 10 records the modified metadata file MDF to the USB memory 6 serving as the local storage, before going to step SP121.

In step SP121, the control block 10 of the BD recorder 2 issues to the video streaming server 5 a request to stop the streaming reproduction of the favorite moving picture scene based on the end point time code T2 in effect before the update. From step SP121, the control block 10 goes to step SP122 and terminates the process.

In step SP135, the streaming management block 50 of the video streaming server 5 stops the ongoing streaming distribution of the favorite moving picture scene based on the streaming reproduction stop request. From step SP135, the streaming management block 50 goes to step SP136 and terminates the process.

With the content distribution system 1 in operation as described above, the registration start point time code Ts and end point time code Te of the favorite moving picture scene may be replaced by the registration start point time code Ts2 and modified end point time code Te2 respectively in response to the favorites button 19A getting operated by the user UR viewing the favorite moving picture scene that is being reproduced in streaming mode from the video streaming server 5.

The control block 10 of the BD recorder 2 proceeds to update the metadata file MDF using the registration start point time code Ts2 and modified end point time code Te2 of the metadata MD1 regarding the favorite moving picture scene and record the updated metadata file MDF to the USB memory 6 serving as the local storage. This completes the favorite moving picture scene reproduction and modification process.

### [1-9. Operations and Effects]

Where the present invention is embodied as described above, the control block 10 of the BD recorder 2 in the content distribution system 1 causes the user-designated video content to be reproduced in streaming mode from the video streaming server 5 in accordance with the BD-J Appli 31 held on the Blu-ray disk BD.

The control block 10 of the BD recorder 2 determines the registration start point time code Ts and end point time code Te of the favorite moving picture scene in keeping with the favorites button 19A getting operated by the user.

Thereafter, the control block 10 of the BD recorder 2 creates the metadata MD1 through MD3 regarding the favorite moving picture scenes based on the dates in effect upon their registration, their title IDs, registration start point time codes Ts, end point time codes Te, and other data. The control block 10 proceeds to record the created metadata MD1 through MD3 as well as the thumbnail images SG1 through SG3 constituting the favorite moving picture scene information to the USB memory 6 serving as the local storage.

When the recollections album button B2 is selected on the top menu screen TMG, the control block 10 of the BD recorder 2 can create the recollections album screen OAG made up of the introduction screens MG1 through MG3 using the metadata file MDF and thumbnail images SG1 through SG3. The recollections album screen OAG thus created is displayed on the TV set 3.

By presenting the user UR with the introduction screens MG1 through MG3 on the recollections album screen OAG, the control block 10 of the BD recorder 2 allows the user UR visually to check the favorite moving picture scenes currently registered.

In turn, the user UR checks the thumbnail images SG1 through SG3, content titles, and dates displayed on the introduction screens MG1 through MG3. The check will remind the user vividly what titles of video contents were selected as his or her favorites, when they were selected, and what kinds of favorite moving picture scenes associated therewith were registered.

By simply pressing, the thumbnail image SG1 on the introduction screen MG1, the user UR can visually check the reproduced video of the favorite moving picture scene FMS in streaming mode as shown in FIG. 13. This allows the user UR to recall the memories and sensations that the user experienced upon viewing the corresponding video content.

By simply viewing the thumbnail images SG1 through SG3 of the introduction screens MG1 through MG3 one after another, the user UR can also recognize at once what titles of video contents were selected as his or her favorites and what kinds of favorite moving picture scenes were retained as his or her recollections.

Incidentally, the BD recorder 2 can present the user UR with the recollections album screen OAG including the thumbnail images SG1 through SG3 of the introduction screens MG1 through MG3 as a viewing history indicative of the video contents that the user has viewed so far.

Also with the BD recorder 2, the metadata file MDF and thumbnail images SG1 through SG3 are recorded as the favorite moving picture scene information to the USB memory 6 serving as the local storage. In this manner, even if the Blu-ray disk DB of interest is a read-only BD-ROM, the favorite moving scene information about that disk can be preserved unfailingly.

Furthermore, the BD recorder 2 allows the user to modify the temporally delimited range of the video content of interest by suitably operating the favorites button 19A while visually checking the favorite moving picture scene FMS being reproduced in streaming mode. In this manner, the metadata file MDF can be updated to obtain the temporally delimited range of the video content as desired by the user.

In the content distribution system 1 configured as described above, the BD recorder 2 enables the user, who may find a favorite moving picture scene during streaming reproduction of a video content, to easily retain that scene as his or her recollections of the video content by appropriately operating the favorites button 19A at the start time and end time of that favorite moving picture scene.

### 2. Other Variations

In connection with the above-described embodiment, it was shown that each of the thumbnail images SG1 through SG3 is created by reducing to a predetermined size the frame image corresponding to the temporary start point time code TT indicating the point in time at which the favorites button 19A (FIG. 2) on the remote controller 19 was pushed by the user. However, this is not limitative of the present invention. Alternatively, the jacket photo of the commercially available Blu-ray disk corresponding to the video content of interest may be reduced to the predetermined size in order to create each of the thumbnail images SG1 through SG3.

Also in connection with the above-described embodiment, it was shown that the control block 10 of the BD recorder 2 registers the temporally delimited range of the favorite moving picture scene in the USB memory 6 and that the video streaming server 5 reproduces that temporally delimited range in streaming mode. However, this is not limitative of the present invention. Alternatively, the time code of an appropriate point in time corresponding to a favorite still picture scene may be registered in the USB memory 6 so that the still picture corresponding to the time code may be downloaded from the video streaming server 5 and displayed.

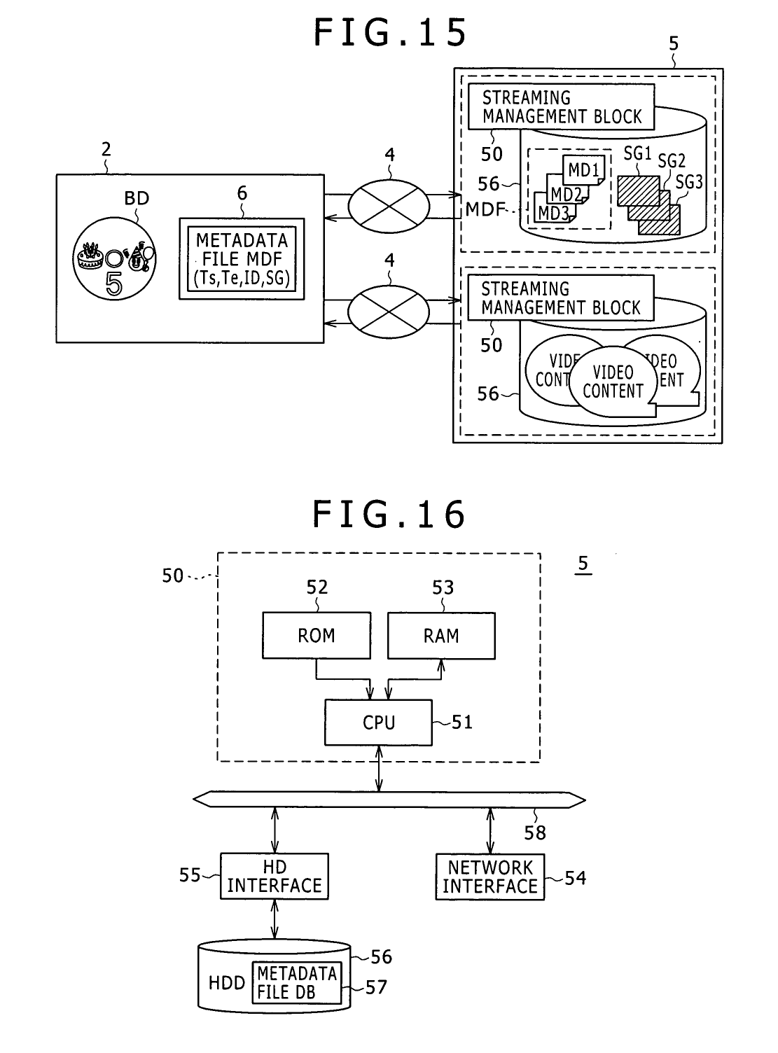

Also in connection with the above-described embodiment, it was shown that the control block 10 of the BD recorder 2 records the metadata file MDF and thumbnail images SG1 through SG3 to the USB memory 6. Alternatively, as shown in FIG. 15, the streaming management block 50 of the video streaming server 5 may receive the metadata file MDF and thumbnail images SG1 through SG3 from the BD recorder 2 and record the received file and images to the hard disk drive 56.

In the case above, as shown in FIG. 16, the video streaming server 5 may establish a metadata file database 57 on the hard disk drive 56 and transmit the metadata file MDF and thumbnail images SG1 through SG3 from the BD recorder 2 to the video streaming server 5 in order to have the metadata file MDF and thumbnail images SG1 through SG3 retained on the metadata file database 57.

At this point, the video streaming server 5 creates the introduction screens MG1 through MG3 using the metadata file MDF and thumbnail images SG1 through SG3, and transmits the recollections album screen OAG composed of these created introduction screens to the BD recorder 2. Also, the video streaming server 5 has the registration start point time code Ts and end point time code Te designated by the BD recorder 2 using the introduction screens MG1 through MG3. In response to the designation, the video streaming server 5 reads the video content of the temporally delimited portion and distributes the retrieved content to the BD recorder 2.

Since the BD recorder 2 does not record the metadata file MDF and thumbnail images SG1 through SG3 to the USB memory 6 as described above, the user UR can avoid the risks stemming from losing or misplacing the USB memory 6 or inadvertently erasing the metadata file MDF and thumbnail images SG1 through SG3 stored therein. It is thus possible to download the favorite moving picture scenes from the video streaming server 5 whenever desired.

Also in connection with the above-described embodiment, it was shown that the frame image corresponding to the temporary start point time code denoting the point in time at which the favorites button 19A (FIG. 2) on the remote controller 19 was pushed is reduced to a predetermined size in order to create each of the thumbnails SG1 through SG3 for display on the introduction screens MG1 through MG3. Alternatively, on the introduction screens MG1 through MG3, the thumbnail images SG1 through SG3 denoting the favorite moving picture scenes may be displayed not as still pictures but directly as moving picture thumbnails.

Also in connection with the above-described embodiment, it was shown that a predetermined backtrack time Tw (e.g., 5 seconds) is subtracted from the temporary start point time code TT to obtain the registration start point time code Ts that backtracks by 5 seconds from the point in time at which the favorites button 19A was pushed. Alternatively, any desired time period may be set as the backtrack time Tw.

Also in connection with the above-described embodiment, it was shown that a predetermined backtrack time Tw2 (e.g., 3 seconds) is subtracted from the temporary start point time code TT2 to acquire the registration start point time code Ts2 that backtracks by 3 seconds from the point in time at which the favorites button 19A was pushed during streaming reproduction of the favorite moving picture scene. Alternatively, any desired time period may be set as the backtrack time Tw2.

It should be noted that the backtrack time Tw2 for modification needs to be shorter than the background time Tw for registration. In this respect, the BD recorder 2 allows the temporally delimited range of the favorite moving picture scene to be modified down to a truly needed time range.

Also in connection with the above-described embodiment, it was shown that the video streaming server 5 performs the authentication process using the disk ID of the Blu-ray disk loaded into the BD recorder 2. Alternatively, an authentication server independent of the video streaming server 5 may be used to carry out the authentication process.

Also in connection with the above-described embodiment, it was shown that the start point time code and end point time code are recorded to the USB memory 6 as the metadata MD1 through MD3 when the favorites button 19A (FIG. 2) is pushed at the start point of the favorite moving picture scene and then released at the end point thereof. Alternatively, the start point time code and end point time code may be recorded to the USB memory 6 as the metadata MD1 through MD3 when the favorites button 19A (FIG. 2) is pushed at the start point of the favorite moving picture scene and again pushed at the end point thereof.

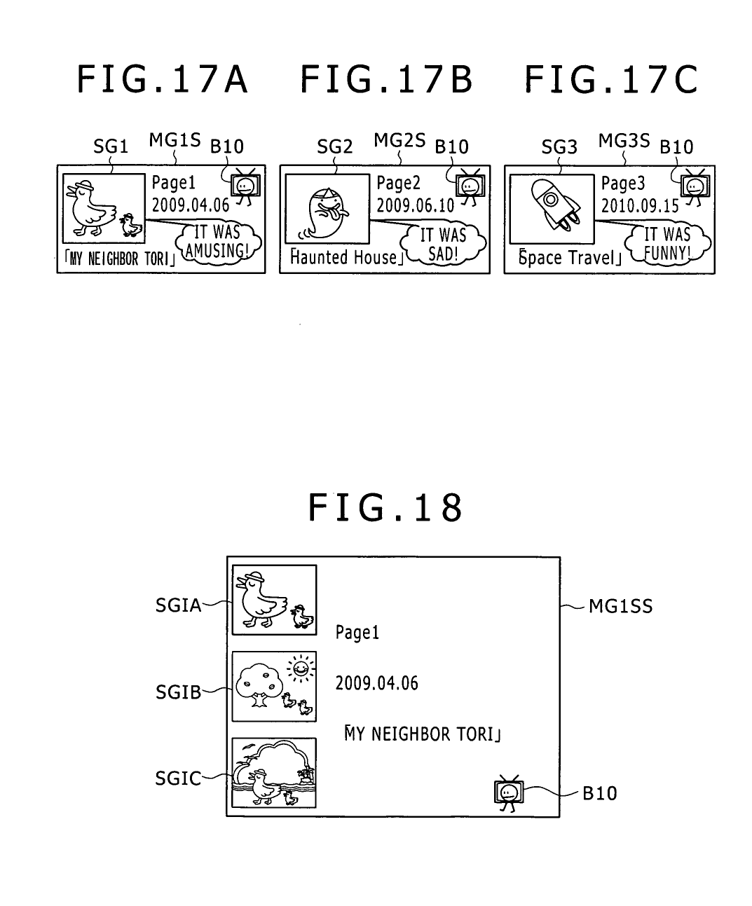

Also in connection with the above-described embodiment, it was shown that the introduction screens MG1 through MG3 indicated in FIGS. 11A, 11B, and 11C respectively are created and displayed. Alternatively, introduction screens MG1S through MG3S with user-written comments may be created and displayed as shown in FIGS. 17A, 17B, and 17C. In this case, the control block 10 of the BD recorder 2 may cause the BD-J Appli 31 to display a software keyboard on the TV set 3. Using the software keyboard thus displayed, the user UR can input desired comments that are to be recorded as the metadata MD1 through MD3.

Also in connection with the above-described embodiment, it was shown that the introduction screens MG1 through MG3 are created and displayed as indicated in FIGS. 11A, 11B, and 11C. Alternatively, user-desired comment voices may be output along with the introduction screens MG1 through MG3 displayed concurrently. This feature is implemented by the control block 10 of the BD recorder 2 having the comment voices picked up in advance and recorded to the USB memory 6 together with the metadata MD1 through MD3.

Also in connection with the above-described embodiment, it was shown that the introduction screens MG1 through MG3 are created and displayed as indicated in FIGS. 11A, 11B, and 11C. Alternatively, as shown in FIG. 18, one screen may be arranged to contain an introduction screen MG1SS created and displayed along with three thumbnail images SG1A, SG1B and SG1C corresponding to three temporally delimited ranges of a single video content.

In the case above, when any one of the thumbnail images SG1A, SG1B and SG1C is pressed, the control block 10 of the BD recorder 2 permits streaming reproduction of the favorite moving picture scene corresponding to the temporally delimited range represented by the pressed thumbnail.

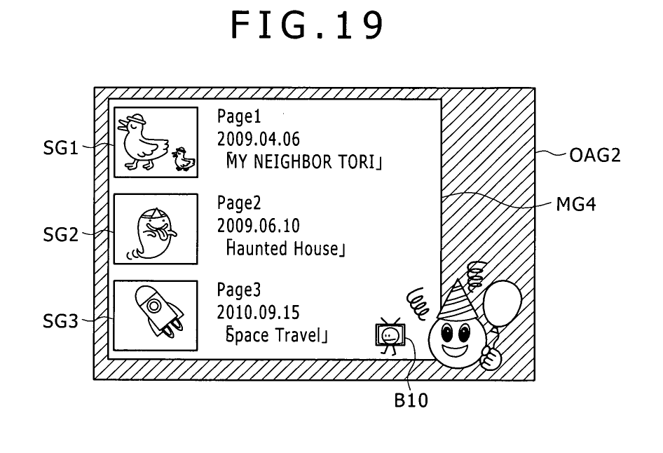

Also in connection with the above-described embodiment, it was shown that the introduction screens MG1 through MG3 are created and displayed as indicated in FIGS. 11A, 11B, and 11C. Alternatively, as shown in FIG. 19, one screen may be arranged to have a recollections album screen OAG2 displayed in a manner containing an introduction screen MG4 created to display the thumbnail images SG1, SG2 and SG3 corresponding to the temporally delimited ranges registered while each of three video contents “My Neighbor Tori,” “Haunted House” and “Space Travel” was being reproduced.

In the case above, when any one of the thumbnail images SG1, SG2 and SG3 is pressed, the control block 10 of the BD recorder 2 permits streaming reproduction of the favorite moving picture scene corresponding to the temporally delimited range designated by the pressed thumbnail as representative of the desired video content.

Also in connection with the above-described embodiment, it was shown that the metadata file MDF is created by the BD-J Appli 31 held on the Blu-ray disk BD and is recorded to the USB memory 6 serving as the external storage device. However, this is not limitative of the present invention. Alternatively, if the Blu-ray disk BD is a BD-RE or some other writable optical disk (i.e., not the read-only type), then the metadata file MDF may be written to a free area on that Blu-ray disk BD.

Also in connection with the above-described embodiment, it was shown that the BD-J Appli 31 held on the Blu-ray disk BD is used to create the metadata file MDF or to create and display the recollections album screen OAG. Alternatively, a suitable application program kept in the USB memory 6 and functionally equivalent to the BD-J Appli 31 may be used to create the metadata file MDF or to create and display the recollections album screen OAG. That is, according to the present invention, the BD-J Appli 31 is not the only application to perform the above-mentioned processes, and the Blu-ray disk BD is not the only storage medium on which that type of application program is retained.

Also in connection with the above-described embodiment, it was shown that the registration start point time codes Ts and Ts2 are each obtained by backtracking by a predetermined time period from the temporary start point time codes TT and TT2 before being recorded to the USB memory 6. Alternatively, the temporary start point time codes TT and TT2 may be recorded unmodified to the USB memory 6 as the registration start point time codes Ts and Ts2.

Also in connection with the above-described embodiment, the end point time code Te in effect when the favorites button 19A was released is recorded unmodified to the USB memory 6. However, this is not limitative of the present invention. Alternatively, the point in time in effect upon elapse of a predetermined time period from the time when the favorites button 19A was released may be recorded to the USB memory 6 as the registration end point time code.

Also in connection with the above-described embodiment, the inventive content reproduction apparatus was shown to include the control block 10 and disk recording/reproduction block 14 serving as the reading device; the control block 10, network interface 24, and output interface 17 as the reception device; the control block 10 and USB interface 20 as the moving picture scene registration device; the control block 10 as the introduction screen creation device; and the control block 10 and network interface 24 as the moving picture scene reproduction device. However, this structure is not limitative of the present invention. Alternatively, the content reproduction apparatus of an embodiment of the present invention may be constituted by the reading device, reception device, moving picture scene registration device, introduction screen creation device, and moving picture scene reproduction device each structured in many other ways.

Also in connection with the above-described embodiment, the inventive content provision apparatus was shown to include the streaming management block 50 and network interface 54 serving as the distribution device; the streaming management block 50 and hard disk interface 55 as the moving picture scene information storage device; and the streaming management block 50 as the introduction screen creation device. However, this structure is not limitative of the present invention. Alternatively, the content provision apparatus of the embodiment of the present invention may be constituted by the distribution device, moving picture scene information storage device, and introduction screen creation device each structured in many other ways.

Also in connection with the above-described embodiment, the inventive content reproduction apparatus was shown to be applied illustratively to the BD recorder 2. However, this is not limitative of the present invention. Alternatively, the content reproduction apparatus of the embodiment of the present invention may be applied to many other pieces of electronic equipment capable of reproducing contents in streaming mode, such as various personal computers, PDAs (personal digital assistant), mobile phones, and video game machines.

The content reproduction apparatus, content provision apparatus, and content distribution system of the embodiment of the present invention are not limited in application to the content distribution system 1 that utilizes the BD recorder 2. The apparatuses and system of the invention may also be applied to other content distribution systems involving the use of digital video cameras and/or digital still cameras.

It should be understood by those skilled in the art that various modifications, combinations, sub-combinations and alterations may occur depending on design requirements and other factors insofar as they are within the scope of the appended claims or the equivalents thereof.

What is claimed is:

1. A content reproduction apparatus, comprising:
reading means for reading a title from a recording medium in accordance with an application program held on said recording medium;
video content display control means for downloading from a content provision apparatus a video content having said title in accordance with said application program and to display said video content on display means;
moving picture scene information creation means for such that while a reproduced image of said video content is being displayed, said moving picture scene information creation means for creating as metadata a start point time and an end point time which correspond to a moving picture scene desired by a user and which are designated by said user, together with a related image invoking said moving picture scene, and said moving picture scene information creation means for further storing said metadata and said related image as moving picture scene information onto external storage means; and
introduction screen creation means for creating an introduction screen for introducing said moving picture scene using said moving picture scene information and to display said introduction screen onto said display means.

2. The content reproduction apparatus according to claim 1, wherein said moving picture scene information creation means stores onto said external storage means a registration start point time reached by backtracking from said start point time by a predetermined time period.

3. The content reproduction apparatus according to claim 2, wherein, while a temporally delimited portion of said video content is being displayed by said moving picture scene reproduction means, said moving picture scene information creation means updates said metadata stored on said external storage means by writing thereto a modified start point time and a modified end point time which are again designated by said user.

4. The content reproduction apparatus according to claim 2, wherein said moving picture scene information creation means creates said metadata using a current date and said title in addition to said registration start point time and said end point time.

5. The content reproduction apparatus according to clam 1, further comprising
moving picture scene reproduction means for such that when said introduction screen is selected, said moving picture scene reproduction means downloads from said content provision apparatus a temporally delimited portion of said video content which corresponds to said moving picture scene designated by said start point time and said end point time, and said moving picture scene reproduction means further displays the downloaded video content portion on said display means.

6. The content reproduction apparatus according to claim 5, further comprising
full reproduction means for such that when a full reproduction button is selected on said introduction screen, said full reproduction means downloads said video content in full and displays said video content on said display means regardless of said start point time and said end point time.

7. The content reproduction apparatus according to claim 1, wherein
said reading means reads from said recording medium unique identification information allotted thereto and submits the read identification information to authentication effected by said content provision apparatus; and
said video content display control means downloads said video content only if said authentication has been successfully completed by said content provision apparatus.

8. A content provision apparatus, comprising:
distribution means for distributing a video content in response to a reproduction start request coming from a content reproduction apparatus regarding a title read from a recording medium in accordance with an application program held on said recording medium;
moving picture scene information storage means for such that while said video content is being distributed by said distribution means, said moving picture scene information storage means receives from said content reproduction apparatus metadata constituted by a start point time and an end point time which correspond to a moving picture scene desired by a user and which are designated by said user, and said moving picture scene information storage means further receives a related image invoking said moving picture scene from said content reproduction apparatus before storing said metadata and said related image as moving scene information onto storage means; and
introduction screen creation means for creating an introduction screen for introducing said moving picture scene using said moving picture scene information and to transmit said introduction screen to said content reproduction apparatus.

9. The content provision apparatus according to claim 8, further comprising
moving picture scene reproduction means for such that when said introduction screen is selected by said content reproduction apparatus, said moving picture scene reproduction means reads as said moving picture scene a temporally delimited portion of said video content which corresponds to said start point time and said end point time, and said moving picture scene reproduction means further distributes said moving picture scene to said content reproduction apparatus.

10. A content distribution system, comprising:
a content reproduction apparatus; and
a content provision apparatus connected to said content reproduction apparatus via a network; wherein
said content reproduction apparatus includes
reading means for reading a title from a recording medium in accordance with an application program held on said recording medium;
video content display control means for downloading from said content provision apparatus a video content having said title in accordance with said application program and to display said video content on display means;
moving picture scene information creation means for such that while a reproduced image of said video content is being displayed, said moving picture scene information creation means creates as metadata a start point time and an end point time which correspond to a moving picture scene desired by a user and which are designated by said user, together with a related image invoking said moving picture scene, and said moving picture scene information creation means further stores said metadata and said related image as moving picture scene information onto external storage means;
introduction screen creation means for creating an introduction screen for introducing said moving picture scene using said moving picture scene information and to display said introduction screen onto said display means;
transmission means for such that when said introduction screen is selected, said transmission means transmits to said content provision apparatus a reproduction start request for a temporally delimited portion of said video content which corresponds to said moving picture scene designated by said start point time and said end point time; and
moving picture scene reproduction means for downloading said video content corresponding to said reproduction start request from said content provision apparatus and to display said video content on said display means; and
said content provision apparatus includes
distribution means for distributing said temporally delimited portion of said video content corresponding to said reproduction start request coming from said content reproduction apparatus regarding said video content having said title.

11. A content distribution system, comprising:
a content reproduction apparatus; and
a content provision apparatus connected to said content reproduction apparatus via a network; wherein
said content reproduction apparatus includes
reading means for reading a title from a recording medium in accordance with an application program held on said recording medium;
video content display control means for downloading from said content provision apparatus a video content having said title in accordance with said application program and to display said video content on display means; and
moving picture scene information creation means for such that while a reproduced image of said video content is being displayed, said moving picture scene information creation means creates as metadata a start point time and an end point time which correspond to a moving picture scene desired by a user and which are designated by said user, together with a related image invoking said moving picture scene, and said moving picture scene information creation means further transmits said metadata and said related image as moving picture scene information to said content provision apparatus; and
said content provision apparatus includes
distribution means for distributing said video content in response to a reproduction start request coming from said content reproduction apparatus regarding said video content having said title;
moving picture scene information storage means for receiving said moving picture scene information from said content reproduction apparatus and to store said moving picture scene information onto storage means; and
introduction screen creation means for creating an introduction screen for introducing said moving picture scene using said moving picture scene information and to transmit said introduction screen to said content reproduction apparatus.

12. A content reproduction apparatus, comprising:
a reading device configured to read a title from a recording medium in accordance with an application program held on said recording medium;
a video content display control device configured to download from a content provision apparatus a video content having said title in accordance with said application program and to display said video content on a display device;
a moving picture scene information creation device configured such that while a reproduced image of said video content is being displayed, said moving picture scene information creation device creates as metadata a start point time and an end point time which correspond to a moving picture scene desired by a user and which are designated by said user, together with a related image invoking said moving picture scene, and said moving picture scene information creation device further stores said metadata and said related image as moving picture scene information onto an external storage device; and
an introduction screen creation device configured to create an introduction screen for introducing said moving picture scene using said moving picture scene information and to display said introduction screen onto said display device.
